(19) United States
(12) Patent Application Publication
(10) Pub. No.: US 2021/0088884 A1
(43) Pub. Date: Mar. 25, 2021

(54) LIGHT SOURCE DEVICE AND PROJECTOR

(71) Applicant: SEIKO EPSON CORPORATION, Tokyo (JP)

(72) Inventor: Hiroaki YANAI, Azumino-shi, Nagano-ken (JP)

(21) Appl. No.: 17/024,934

(22) Filed: Sep. 18, 2020

(30) Foreign Application Priority Data
Sep. 20, 2019 (JP) 2019-171300

(51) Int. Cl. G03B 21/16; G03B 21/20; G03B 21/14; H04N 9/31

(52) U.S. Cl. CPC G03B 21/16; H04N 9/3161; G03B 21/145; G03B 21/204

(57) ABSTRACT

The light source device includes a light source configured. to emit light, an optical element configured to affect the light emitted from the light source, a first case configured to house the light source and the optical element inside, a blower configured to deliver air to inside of the first case, and a second case configured to house the blower inside and coupled to the first case. The first case includes a blast port through which the air delivered from the blower passes into the first case, and a circulation port through which the ai inside the first case passes into the second case.

The present application is based on, and claims priority from JP Application Serial Number 2019-171300, filed Sep. 20, 2019, the disclosure of which is hereby incorporated by reference herein in its entirety.

### BACKGROUND

### 1. Technical Field

The present disclosure relates to a light source device and a projector.

### 2. Related Art

In the past, in a projector, when dust adheres to an optical element such as a lens housed inside the chassis, there is a possibility of incurring degradation of the image quality. Therefore, there is a projector which takes in the ambient air through an intake port provided to an exterior chassis with a cooling fan to thereby keep the inside of the exterior chassis in a positive pressure state, and thus, prevents the dust from invading inside the exterior chassis (see, e.g., JP-A-2005-181400).

However, although it is possible to prevent the dust from invading from the outside by making the inside of the exterior chassis positive in pressure during the period in which the projector described above is in operation, there is a possibility that, for example, the dust which has invaded inside through an exhaust port or a gap of the exterior chassis when driving of the projector is stopped adheres to the optical element to thereby degrade the reliability.

### SUMMARY

A light source device according to an aspect of the present disclosure includes a light source configured to emit light, an optical element configured to affect the light emitted from the light source, a first case configured to house the light source and the optical element inside, a blower configured to deliver air to inside of the first case, and a second case configured to house the blower inside and coupled to the first case. The first case includes a blast port through which the air delivered from the blower passes into the first case, and a circulation port through which the air inside the first case passes into the second case.

The light source device may be configured such that a first air amount per unit time of the air flowing into the first case via the blast port is higher than a second air amount per unit time of the air flowing into the second case from the first case via the circulation port.

The light source device may be configured such that the second case includes an intake port through which air outside the light source device passes into the second case.

The light source device may be configured to further include a first filter disposed at the blast port, and a second filter disposed at the intake port. A capturing efficiency of first filter may be higher than a capturing efficiency of the second filter.

The light source device may be configured to further include a third filter disposed at the circulation port. A capturing efficiency of the third filter may be lower than the capturing efficiency of the first filter and be higher than the capturing efficiency of the second filter.

The light source device may be configured to further include a first filter disposed at the blast port, and a second filter disposed at the intake port. A capturing efficiency of the second filter may be higher than a capturing efficiency of the first filter.

The light source device may be configured to further include a third filter disposed at the circulation port. A capturing efficiency of the third filter may be lower than the capturing efficiency of the first filter.

A projector according to another aspect of the present disclosure includes the light source device described above, a light modulator configured to modulate light emitted from the light source device in accordance with image information, and a projection optical device configured to project the light modulated by the light modulator.

### BRIEF DESCRIPTION OF THE DRAWINGS

FIG. 1 is a plan view showing a schematic configuration of a projector according to an embodiment.

FIG. 2 is a perspective view showing a schematic configuration. of a light source device.

FIG. 3 is an enlarged view of an essential part of a light source device according to a modified example.

### DESCRIPTION OF AN EXEMPLARY EMBODIMENT

An embodiment of the present disclosure will hereinafter be described in detail with reference to the drawings. It should be noted that the drawings used in the following description show characteristic parts in an enlarged manner in some cases for the sake of convenience in order to make the features easy to understand, and the dimensional ratios between the constituents and so on are not necessarily the same as actual ones.

### Projector

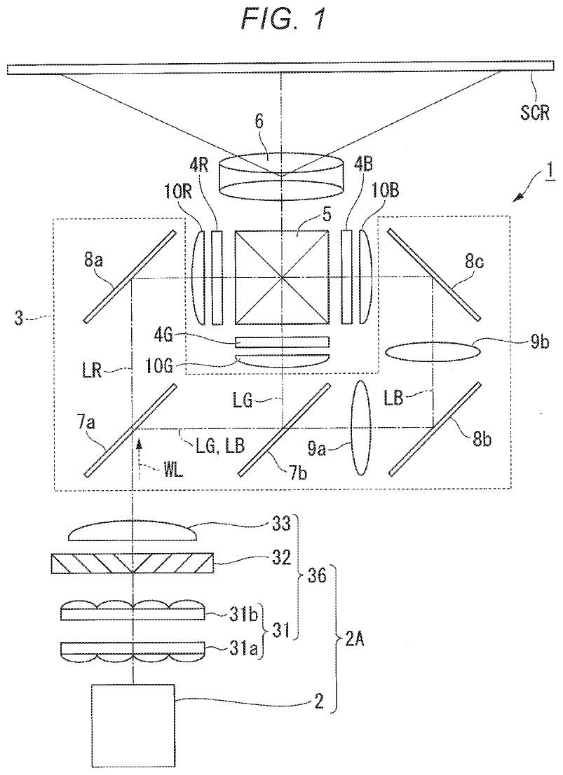

FIG. 1 is a plan view showing a schematic configuration of the projector according to the present embodiment.

As shown in FIG. 1, the projector 1 according to the present embodiment is a projection-type image display device for displaying a color picture (image) on a screen SCR. The projector 1 uses three light modulators corresponding to respective colored light beams, namely red light LR, green light LG, and blue light LB. The projector 1 uses semiconductor lasers (laser sources), with which high-intensity and high-power light can be obtained, as a light source of an illumination device.

Specifically, the projector 1 iS provided with an illumination device 2A, a color separation optical system 3, a light modulator 4R, a light modulator 4G, a light modulator 4B, a combining optical system 5, and a projection optical device 6.

The illumination device 2A emits illumination light WL toward the color separation optical system 3. The illumination device 2A includes a light source device 2 and a homogenous illumination optical system 36.

The homogenous illumination optical system 36 is provided with an integrator optical system 31, a polarization conversion element 32, and a superimposing optical system 33. It should be noted that the polarization conversion element 32 is not an essential element. The homogenous illumination optical system 36 homogenizes the intensity distribution of the illumination light WL emitted from the light source device 2 in an illumination target area.

The integrator optical system 31 is constituted by, for example, lens arrays 31a, 31b. The lens arrays 31a, 31b are each formed of what has a plurality of lenses arranged in an array.

The illumination light WL having passed through the integrator optical system 31 enters the polarization conversion element 32. The polarization conversion element 32 is constituted. by, for example, a polarization split film and a wave plate, and converts the illumination light WL into linearly polarized light.

The illumination light WL having passed through the polarization conversion element 32 enters the superimposing optical system 33. The superimposing optical system 33 is formed of, for example, a convex lens, and superimposes the illumination light WL emitted from the polarization conversion element 32 on the illumination target area. In the present embodiment, the luminance distribution in the illumination target area is homogenized by the integrator optical system 31 and the superimposing optical system 33.

The illumination light WL having been emitted from the homogenous illumination optical system 36 enters the color separation optical system 3.

The color separation optical system 3 is for separating illumination light WL into the red light LR, the green light LG, and the blue light LB. The color separation optical system 3 is generally provided with a first dichroic mirror 7a and a second dichroic mirror 7b, a first total reflection mirror 8a, a second total reflection mirror 8b and a third total reflection mirror 8c, and a first relay lens 9a and a second relay lens 9b.

The first dichroic mirror 7a separates the illumination light WL from the light source device 2 into the red light LR and the other light (the green light LG and the blue light LB). The first dichroic mirror 7a transmits the red light LR, and at the same time, reflects the other light (the green light LG and the blue light LB). Meanwhile, the second dichroic mirror 7b separates the other light into the green light LG and the blue light LB. The second dichroic mirror 7b reflects the green light LG and at the same time transmits the blue light LB.

The first total reflection mirror 8a reflects the red light LR, which has been transmitted through the first dichroic mirror 7a, toward the light modulator 4R. The second total reflection mirror 8b and the third total reflection mirror 8c reflect the blue Light beam LB, which has been transmitted through the second dichroic mirror 7b, toward the light modulator 4B. The green light LG is reflected by the second dichroic mirror 7b toward the light modulator 4G.

The first relay lens 9a and the second relay lens 9b are disposed on the light exit side of the second dichroic mirror 7b in the light path of the blue light LB.

The light modulator 4R modulates the red light LR in accordance with image information to form red image light. The light modulator 4G modulates the green light LG in accordance with the image information to form green image light. The light modulator 4B modulates the blue light LB in accordance with image information. to form blue image light.

As the light modulator 4R, the light modulator 4G, and the light modulator 4B, there are used, for example, transmissive liquid crystal panels. Further, in the incident side and the exit side of each of the liquid crystal panels, there are respectively disposed a pair of polarization plates (not shown).

On the incident side of the light modulator 4R, the light modulator 4G, and the light modulator 4B, there are disposed a field lens 10R, a field lens 10G, and a field lens 10B, respectively.

The combining optical system 5 combines the image light from the light modulator 4R, the image light from the light modulator 4G, and the image light from the light modulator 4B with each other to emit the result toward the projection optical device 6. As the combining optical system 5, there is used, for example, a cross dichroic prism.

The projection optical device 6 is formed of a projection lens group. The projection optical device 6 projects the image light having been combined by the combining optical system 5 toward the screen SCR in an enlarged manner.

### Light Source Device

Then, the light source device 2, to which an aspect of the present disclosure is applied, and which is used for the illumination device 2A described above, will be described.

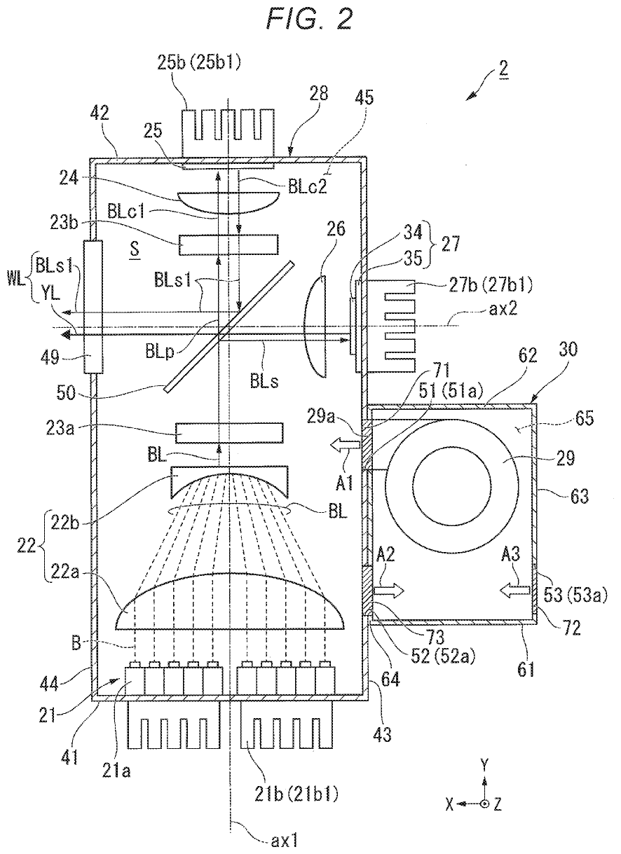

FIG. 2 is a perspective view showing a schematic configuration of the light source device. In FIG. 2, in order to make the drawing eye-friendly, the illustration of an upper plate part of a first case 28 and an upper plate part of a second case 30 described later is omitted. In the drawings used hereinafter, the positional relationship between the members is described arbitrarily using an XYZ coordinate system. In FIG. 2, a Z direction along the Z axis corresponds to a vertical direction, an X direction along the X axis perpendicular to the Z axis corresponds to a light, exit, direction by the light source device 2, and the Y axis is perpendicular to the X axis and the Z axis. It should be noted that although in FIG. the description will be presented assuming the Z direction along the Z axis as the vertical direction, the vertical direction changes in accordance with the installation posture of the projector 1.

As shown in FIG. 2, the light source device 2 is provided with a light source 21, a first cooling member 21b, an afocal optical system (an optical element) 22, a first wave plate 23a, a light splitting/combining element 50, a second wave plate 23b, a first pickup lens 24, a diffusion element 25, a second cooling member 25b, a second pickup lens 26, a fluorescence emitting element 27, a third cooling member 27b, the first case 28, a blast fan (a blower) 29, the second case 30, a blowing dust collection filter (a first filter) 71, a circulating dust collection filter (a third filter) 73, and an air-intake dust collection filter (a second filter) 72.

The first cooling member 21b, the light source 21, the afocal optical system 22, the first wave plate 23a, the light splitting/combining element 50, the second wave plate 23b, the first pickup lens 24, the diffusion element 25, and the second cooling member 25b are disposed in sequence on a light axis ax1. Further, the third cooling member 27b, the fluorescence emitting element 27, the second. pickup lens 26, and the light splitting/combining element 50 are disposed in sequence on an illumination light axis ax2. The light axis ax1 and the illumination light axis ax2 are located in the same plane, and. are perpendicular to each other.

The first case 28 is made of metal, and constitutes the exterior chassis of the light source device 2. The first case 28 has a housing space S. In the housing space S, there are housed the light source 21, the afocal optical system 22, the first wave plate 23a, the light splitting/combining element 50, the second wave plate 23b, the first pickup lens 24, the diffusion element 25, the second pickup lens 26, and the fluorescence emitting element 27. In other words, the light source 21 and the optical elements such as the afocal optical system 22, the first wave plate 23a, the light splitting/combining element 50, the second wave plate 23b, the first pickup lens 24, the diffusion element 25, the second pickup lens 26, and the fluorescence emitting element 27 are housed inside the first case 28. These optical elements affects the light emitted from the light source 21 although described later detail.

The first case 28 has a first side plate part 41, a second side plate part 42, a third side plate part 43, a fourth side plate part 44, a bottom plate part 45, and the upper plate part not shown. To the inner side of the first side plate part 41, there is attached the light source 21, and to the cuter side of the first side plate part 41, there is attached the first cooling member 21b.

The second side plate part 42 is disposed so as to be opposed to the first side plate part 41, the diffusion element 25 is attached to the inner side of the second side plate part 42, and the second cooling member 25b is attached to the outside of the second side plate part 42.

The third side plate part 43 is a member which extends in a direction crossing the first side plate part 41 and the second sideplate part 42. To the inner side of the third side plate part 43, there is attached the fluorescence emitting element 27, and to the outer side of the third side plate part 43, there is attached the third cooling member 27b.

The fourth side plate part 44 is a member which is opposed to the third side plate part 43, and extends in a direction crossing the first side plate part 41 and the second side plate part 42. It should be noted. that in the present embodiment, the third side plate part 43 and the fourth side plate part 44 each extend in a direction perpendicular to the first side plate part 41 and the second side plate part 42. The fourth side plate part 44 has a light exit part 49 which is disposed on the left side (the +X side) of the light splitting/combining element 50, and transmits the illumination light combined by the light splitting/combining element 50 and then emitted toward the outside. The light exit part 49 is, for example, a window made of a light transmissive member provided to the fourth side plate part 44.

The bottom plate part 45 is a member extending in a direction crossing the first side plate part 41, the second side plate part 42, the third side plate part 43, and the fourth side plate part 44, and forms a bottom plate of the first case 28. It should be noted that in the present embodiment, the bottom plate part 45 extends in a direction perpendicular to the first side plate part 41, the second side plate part 42, the third side plate part 43, and the fourth side plate part 44.

The blast fan 29 feeds the air to the housing space S in the first case 28. In the present embodiment, the blast fan 29 is a sirocco fan excellent in quietness. The second case 30 houses the blast fan 29 inside.

The second case 30 has a first side plate part 61, a second side plate part 62, a third side plate part 63, a fourth side plate part 64, a bottom plate part 65, and the upper plate part riot shown.

The second case 30 is coupled to the first case 28. Specifically, the second case 30 is fixed to the first case 28 via a screw member or the like not shown so as to make the fourth side plate part 64 have contact with the third side plate part 43 of the first case 28.

In the present embodiment, the first case 28 and the second case 30 have a blast port 51 and a circulation port 52. The blast port 51 and the circulation port 52 are common to the first case 28 and the second case 30, and are disposed in the vicinity of the afocal optical system 22 housed inside the first case 28.

Specifically, the blast port 51 is disposed in the vicinity of a concave lens 22b constituting the afocal optical system 22, and the circulation port 52 is disposed in the vicinity of a convex lens 22a constituting the afocal optical system 22.

The blast port 51 is a supply port for supplying the air fed from the blast fan 29 to the inside of the first case 28. The blast port 51 is a through hole 51a penetrating the third side plate part 43 in the first case 28 and the fourth side plate part 64 in the second. case 30. Further, the blast port 51 is provided with the blowing dust collection filter (the first filter) 71. The blowing dust collection filter 71 is a filter capable of capturing the dust included in the air passing through the blast port 51.

To the blast port 51, there is coupled a blast port 29a of the blast fan 29. Thus, it is possible for the blast port 51 to make the air fed from the blast fan 29 flow into the housing space S inside the first case 28. The dust is removed from the air flowing into the housing space S in the process in which the air passes through the blowing dust collection filter 71. Therefore, according to the light source device 2 in the present embodiment, the air which does not include the dust and is high in cleanliness can be supplied to the inside of the housing space S. Here, the description of high in cleanliness means that the proportion of the dust included in the air is relatively low.

The circulation port 52 is an exhaust port for discharging the air inside the housing space S of the first case 28 to the inside of the second case 30. A part of the air which has flowed into the housing space S in the first case 28 due to the blast fan 29 is circulated to the inside of the second case 30 via the circulation port 52. In other words, in the light source device 2 according to the present embodiment, it is possible to circulate the air between the housing space S in the first case 28 and the space in the second case 30.

The circulation port 52 is a through hole 52a penetrating the third side plate part 43 in the first case 28 and the fourth side plate part 64 in the second case 30. Further, the circulation port 52 is provided with the circulating dust collection filter (the third filter) 73. The circulating dust collection filter 73 is a filter capable of capturing the dust included in the air passing through the circulation port 52.

The light source device 2 according to the present embodiment controls the blast volume by the blast fan 29 so as to set the housing space S in the first case 28 to the positive pressure state with respect to the atmosphere outside the first case 28. Here, the atmosphere outside the first case 28 includes the space inside the second case 30 in addition to the space outside the first case 28. Specifically, in the light source device 2, an air supply amount (a first air amount) A1 per unit time flowing into the first case 28 due to the blast fan 29 via the blast port 51 is higher than an air supply amount (a second air amount) A2 per unit time flowing into the second case 30 from the inside of the first case 28 via the circulation port 52. Thus, the housing space S in the first case 28 is kept in the positive pressure state with. respect to the atmosphere outside the first case 28.

In the present embodiment, the blowing dust collection filter 71 has the capturing efficiency higher than the capturing efficiency of the circulating dust collection filter 73. Here, the capturing efficiency is determined by the fineness of the filter material. A fine filter material has high capturing efficiency, and a coarse filter material has low capturing efficiency.

By setting the capturing efficiency of the blowing dust collection filter 71 higher than the capturing efficiency of the circulating dust collection filter 7 as described above, the dust including in the air passing through the blowing dust collection filter 71 is efficiently removed, and therefore, it is possible to further increase the cleanliness of the air in the housing space S.

In the light source device 2 according to the present embodiment, the housing space S in the first case 28 is kept in a relatively-tight hermetic state. However, since the plurality of members is housed in the housing space S in an assembled state as described above, there is adopted a fixation structure using screw members or spring members excellent in easiness in assembly and reduction in cost. Therefore, the first case 28 is constituted by two or more components assembled with each other, and is in a state in which gaps exist between, the components wherein gases can flow through the gaps. It is conceivable t.o block such gaps with sponge or a tape, but it is difficult to achieve a completely hermetic state. Since the housing space S is not in the completely hermetic state as described above, there is a possibility that the dust invades the housing space S via the gaps described above.

In contrast, in the light source device 2 according to the present embodiment, since the housing space S in the first case 28 is kept in the positive pressure state with respect to the external atmosphere, it is possible to prevent the dust from invading inside the housing space S via the gaps described above.

Incidentally, when, for example, setting the power of the projector 1 to the OFF state, the drive of the blast fan 29 in the light source device 2 also stops. When the blast fan 29 stops as described above, external air (ambient air) including the dust invades inside the housing space S via the gaps described above in some cases. In other words, the housing space S goes into the state in which the dust exists in the housing space S. When the dust having invaded inside the housing space S adheres to the components housing in the housing space 5, there is a possibility of causing a problem of deterioration in light transmission rate or heat generation in each of the components.

In contrast, in the light source device 2 according to the present embodiment, it is possible to discharge the air from the housing space S in the first case 28 to the inside of the second case 30 via the circulation port 52. The dust is removed from the air flowing into the second case 30 via the circulation port 52 in the process in which the air passes through the circulating dust collection filter 73. According to the light source device 2 related to the present embodiment, by making the air inside the housing space S of the first case 28 flow into the second case 30 via the circulation port 52, it is possible to discharge the dust included in the air inside the housing space S. Therefore, according to the light source device 2 related to the present embodiment, it is possible to keep the housing space S of the first case 28 in the state high in cleanliness.

Further, in the light source device 2 according to the present embodiment, the second case 30 has an intake port 53. The intake port 53 is a supply port for allowing the air located outside the light source device 2 to flow into the inside of the second case 30. The light source device 2 according to the present embodiment is installed in the projector 1 so as to be able to take in the ambient air via the intake port 53.

The intake port 53 is a through hole 53a penetrating the third side plate part 63 in the second case 30. Further, the intake port 53 is provided with the air-intake dust collection filter (the second filter') 72. The air-intake dust collection filter 72 is a filter capable of capturing the dust included in the air passing through the intake port 53.

When the blast fan 29 continues to make the air flow into the first case 28, the pressure in the internal space of the second case 30 gradually decreases, and there is a possibility that the blast volume of the blast fan 29 decreases. In contrast, according to the light source device 2 related to the present embodiment, since the ambient air A3 is supplied from the outside to the inside of the second case 30 via the intake port 53, it is possible for the blast fan 29 to continue to stably supply the air to the inside of the first case 28.

Further, the air located outside the light source device 2 includes more dust compared to the internal space of the second case 30. The dust is removed from the ambient air A3 flowing into the second case 30 via the intake port 53 in the process in which the ambient air A3 passes through the air-intake dust collection filter 72. Therefore, according to the light source device 2 related to the present embodiment, when taking in the ambient air A3 inside the second case 30, it is possible to prevent the dust from invading inside the second case 30. Therefore, it is possible to keep the internal space of the second. case 30 in the state high in cleanliness.

In the light source device 2 according to the present embodiment, since the air located inside the second case 30 is made to flow into the first case 28 with the blast fan 29, by keeping the internal space of the second case 30 in the state high in cleanliness as described above, it is possible to further increase the cleanliness of the air flowing into the first case 28.

In particular, in the light source device 2 according to the present embodiment, since a pencil BL constituted by laser beams high in energy density is emitted from the light source 21, the optical dust collection effect is apt to particularly conspicuously occur. Specifically, the dust is apt to adhere to a surface of the convex lens 22a or the concave lens 22b constituting the afocal optical system, 22 which the pencil BL enters due to the optical dust collection effect, and there is a possibility that the transmission rate of each of the lenses 22a, 22b degrades to thereby darken the illumination light WL to incur the deterioration in image quality of the projector 1. Further, there is also a possibility that the dust having adhered to the lenses 22a, 22b is burnt-in to thereby damage the lenses 22a, 22b.

According to the light source device 2 related to the present embodiment, by keeping the housing space S in the positive pressure state, it is possible to prevent the dust from invading inside the housing space S from the outside. Further, according to the light source device 2 related to the present embodiment, for example, even when the dust invades inside the housing space S during the period in which the projector 1 is in the power OFF state, it is possible to discharge the dust thus having invaded inside the housing space S from the circulation port 52 when the blast fan 29 is driven again in the light source device 2.

As described above, according to the light source device 2 related to the present embodiment, it is possible to keep the housing space S in the state high in cleanliness. Therefore, it is possible to prevent the adhesion of the dust due to the optical dust collection effect to the afocal optical system 22 housed inside the housing space S. Further, since the housing space S is kept in the state few in dust and high in cleanliness, it is also possible to prevent the adhesion of the dust to the first wave plate 23a, the light splitting/combining element 50, the second wave plate 23b, the first pickup lens 24, the diffusion element 25, the second pickup lens 26, or the fluorescence emitting element 27 housed in the housing space S.

In the present embodiment, it is possible for the blowing dust collection filter 71 to have the capturing efficiency higher than the capturing efficiency of the air-intake dust collection filter 72. According to this configuration, it is possible to make it easy to take in the ambient air to the inside of the second case 30 via the intake port 53. Further, by the blowing dust collection filter 71 efficiently capturing the dust, it is possible to supply the air high in cleanliness to the inside of the housing space S.

Further, in the present embodiment, it is possible for the circulating dust collection filter 73 to have the capturing efficiency lower than the capturing efficiency of the blowing dust collection filter 71 and higher than the capturing efficiency the air-intake dust collection filter 72. For example, it is also possible to set the capturing efficiency descending in the order of the blowing dust collection filter 71, the circulating dust collection filter 73, and the air-intake dust collection filter 72.

According to this configuration, it is possible to make it easy to take in the ambient air to the inside of the second case 30 via the intake port 53, and at the same time, it becomes easy to keep the housing space S in the positive pressure state as described above.

Alternatively, in the present embodiment, it is possible for the air-intake dust collection, filter 72 to have the capturing efficiency higher than the capturing efficiency of the blowing dust collection filter 71. According to this configuration, for example, when the ambient air is low in cleanliness and includes much dust, it is possible to prevent the invasion of the dust from the outside.

Further, in the present embodiment, it is possible for the circulating dust collection filter 73 to have the capturing efficiency lower than the capturing efficiency of the blowing dust collection filter 71. For example, it s also possible to set the capturing efficiency descending in the order of the air-intake dust collection filter 72, the blowing dust collection filter 71, and the circulating dust collection filter 73.

According to this configuration, it is possible to prevent the invasion of the dust through the intake port 53 while increasing the circulation of the air between the first case 28 and the second case 30.

The light source 21 for emitting the light has a plurality of semiconductor lasers 21a. The light source 21 has a package structure having the plurality of semiconductor lasers 21a arranged in an array in a plane perpendicular to the light axis ax1. The semiconductor lasers 21a each emit, for example, a blue light beam B as excitation light described: later. The blue light beam B is, for example, a laser beam with a peak wavelength of 460 nm. The light beam B emitted from each of the semiconductor lasers not shown is emitted in a state of being converted by a collimator lens 21a1 into parallel light. In the present embodiment, the light source 21 emits the pencil BL formed of the plurality of light beams B. It should be noted that the number of the semiconductor lasers 21a is not limited.

The cool1nq member 21b is a heatsink having a plurality of fins 21b1, and is thermally coupled to the plurality of semiconductor lasers 21a. Here, the expression that two members are thermally coupled to each other means the state in which the heat transfer can be achieved between the two members, and includes the state in which the two members have indirect contact with each other via a thermally-conductive member in addition to the state in which the two members have direct contact with each other. In the present embodiment, the first cooling member 21b is thermally coupled to the light source 21 via the first side plate part 41. Thus, the heat generated in the light source 21 is released from the first cooling member 21b. The first cooling member 21b is formed of a metal member high in heat radiation property. It should he noted that it is also possible to arrange that the cooling performance of the first cooling member 21b is increased by feeding the air to the plurality of fins 21b1 of the first cooling member 21b with a cooling fan not shown.

The pencil BL emitted from the light source 21 enters the afocal optical system 22. The afocal optical system 22 has, for example, the convex lens 22a and the concave lens 22b. The afocal optical system 22 functions so as to reduce the beam diameter of the pencil BL having been emitted from the light source 21.

The pencil BL having been reduced in beam diameter by the afocal optical system 22 enters the first wave plate 23a. The first wave plate 23a is, for example, a ½ wave plate which is made rotatable. The pencil BL emitted from the light source 21 is linearly polarized light. By appropriately setting the rotational angle of the first wave plate 23a, light beams including an S-polarization component and a P-polarization component with respect to the light splitting/combining element 50 at a predetermined rate can be obtained as the pencil BL transmitted through the first wave plate 23a. It should be noted that by rotating the first wave plate 23a, it is possible to change the ratio between the S-polarization component and the P-polarization component.

The pencil BL, which is generated bypassing through the first wave plate 23a, and includes the S-polarization component and the P-polarization component, enters the light splitting/combining element 50. The light splitting combining element 50 is arranged so as to form an angle of 45° with respect to each of the light axis ax1 and the illumination light axis ax2.

The light splitting/combining element 50 has a polarization split function of splitting the pencil Bt into a light beam BLs as the S-polarization component and a light beam BLp as the P-polarization component with respect to the light splitting/combining element 50. Further, the light splitting/combining element 50 has a color separation function of transmitting the fluorescence YL different in wavelength band from the pencil BL irrespective of the polarization state of the fluorescence YL. Thus, the light splitting/combining element 50 functions as a combining unit for combining an S-polarization component (the light beam BLs) as a part of the pencil BL and the fluorescence YL with each other as described later.

Specifically, the light splitting/combining element 50 reflects the light beam BLs as the S-polarization component, and transmits the light beam BLp as the P-polarization component. The light beam BLp as the P-polarization component having been transmitted through the light splitting/combining element 50 enters the second wave plate 23b.

The second wave plate 23b is formed of a ¼ wave plate disposed in the light path between the light splitting/combining element 50 and the diffusion element 25. Therefore, the light beam BLp as the P-polarized light having been emitted from the light splitting/combining element 50 is converted by the second wave plate 23b into blue light BLc1 as circularly polarized light, and then enters the first pickup lens 24. The first pickup lens 24 makes the blue light BLc1 enter the diffusion element 25 in a converged state.

The diffusion element 25 diffusely reflects the blue light BLc1, which has been emitted from the first pickup lens 24, toward the light splitting/combining element 50. In other words, the diffusion element 25 in the present embodiment is a reflective diffusion element. The second cooling member 25b is thermally coupled to the diffusion element 25 via the second side plate part 42. The second cooling member 25b is a heatsink having a plurality of fins 25b1. Thus, the heat generated in the diffusion element 25 is released from the second cooling member 25b. The second cooling member 25b is formed of a metal member high in heat radiation property.

The light diffusely reflected by the diffusion element 25 is hereinafter referred to as blue light BLc2. The blue light BLc2 is collimated by the first pickup lens 24, and then enters the second wave plate 23b once again. The blue light BLc2 is converted by the second wave plate 23b into blue light BLs1 as S-polarized light. The blue light BLs1 as the S-polarized light is reflected by the light splitting/combining element 50 toward the light exit part 49.

Meanwhile, the light beam BLs as the S-polarized light having been reflected by the light splitting/combining element 50 enters the fluorescence emitting element 27 via the second pickup lens 26. The second pickup lens 26 converges the light beam BLs toward a phosphor in the fluorescence emitting element 27. The fluorescence emitting element 27 has the phosphor 34 and a support substrate 35 for supporting the phosphor 34. It should be noted. that between the phosphor 34 and the support substrate 35, there is disposed a reflecting mirror not shown for reflecting a part of the fluorescence YL generated in the phosphor 34 toward the outside. The fluorescence emitting element 27 in the present embodiment is a reflective fluorescence emitting element for emitting the fluorescence YL toward an opposite direction to the incident direction of the light beam BLs.

The third cooling member 27b is thermally coupled. to the fluorescence emitting element 27 via the third side plate part 43. The third cooling member 27b is a heatsink having a plurality of fins 27b1. Thus, the heat generated in the fluorescence emitting element 27 is released from the third cooling member 27b. The third cooling member 27b is formed of a metal member high in heat radiation property.

The phosphor 34 in the present embodiment includes phosphor particles for absorbing the light beam BLs as the excitation light to convert the light beam BLs into the fluorescence YL as the yellow fluorescence, and then emitting the fluorescence YL. As the phosphor particles, there can be used, for example, a YAG (yttrium aluminum garnet) based phosphor.

As the phosphor 34, a phosphor layer obtained by dispersing phosphor particles in an inorganic binder such as alumina, or a phosphor layer obtained by sintering the phosphor particles without using the binder, for example, can preferably be used.

The fluorescence YL having been emitted from the phosphor 34 is collimated by the second pickup lens 26 and then enters the light splitting/combining element 50. The fluorescence YL having entered the light splitting/combining element 50 is transmitted through the light splitting/combining element 50. The fluorescence YL having bees transmitted through the light splitting/combining element 50 is combined with the blue light BLs1 reflected by the light splitting/combining element 50 to thereby generate the illumination. light WL as white light. The illumination light WL is emitted outside the first case 28 from the light exit part 49, and then enters the integrator optical system 31 of the homogenous illumination optical system 36 shown in FIG. 1.

As described above, according to the light source device 2 related to the present embodiment, since it is possible to keep the housing space S in the state high in cleanliness, it is possible to protect the afocal optical system 22 and other optical components housed in the housing space S from the dust. Therefore, there is provided the light source device 2 which can generate the illumination light WL high in luminance throughout a long period of time, and is therefore high in reliability by reducing the decrease in light transmission rate due to the adhesion of the dust and the occurrence of the burn-in of the dust.

Further, according to the projector 1 related to the present. embodiment, since the illumination device 2A provided with the light source device 2 described above is provided, the projector 1 becomes capable of displaying images high in brightness for a long period of time, and therefore, high in reliability.

It should be noted that the present disclosure is not limited to the contents of the embodiment described above, but can arbitrarily be modified within the scope or the spirit of the present disclosure.

For example, in the embodiment described above, there is cited, as an example, when the blast port 51 and the circulation port 52 are formed so as to penetrate the first side plate part 43 of the first case 28 and the fourth side plate part 64 of the second case 30, namely when the first case 28 and the second case 30 have the blast port 51 and the circulation port 52, but the present disclosure is not limited to this example.

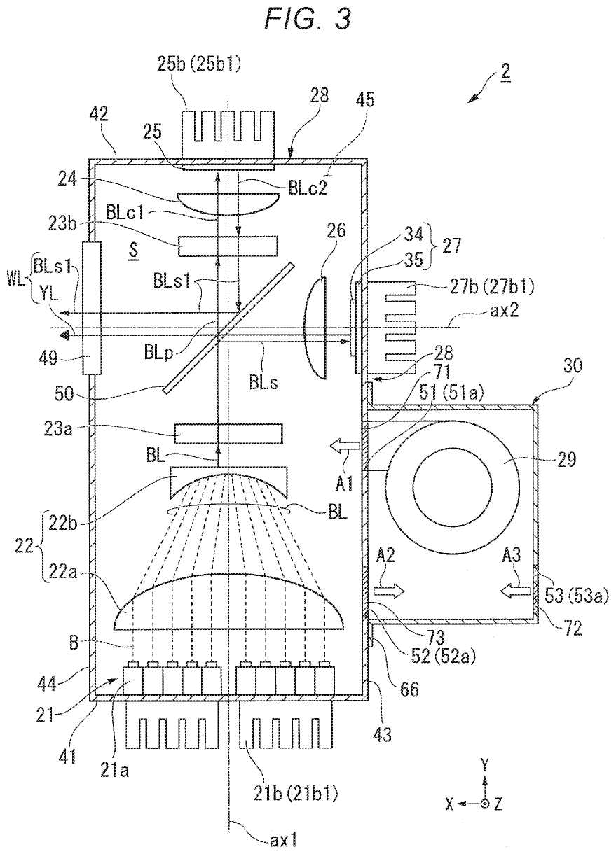

FIG. 3 is an enlarged. view of an essential part of a light source device according to a modified example.

The second case 30 is not required to have a box-like shape. In other words, as shown in FIG. 3, it is possible for the second case 30 to form the housing space for housing the blast fan 29 between the second case 30 and the third side plate part 43 of the first case 28. In this case, since the blast port 51 and the circulation port 52 are provided to the third side plate part 43 of the first case 28, the blast port 51 and the circulation port 52 are only provided to the first case 28. Further, the second case 30 has an attachment plate 66 shaped like a flange for attaching the second case 30 to the third side plate part 43 of the first case 28.

Further, although in the embodiment described above, there is cited, as an example, when making the capturing efficiency of the blowing dust collection filter 71 higher than the capturing efficiency of the circulating dust collection filter 73, the present disclosure is not lira ted to this example. For example, it is possible for the circulating dust collection filter 73 to have the capturing efficiency higher than the capturing efficiency of the blowing dust collection filter 71. By making the capturing efficiency of the circulating dust collection filter 73 higher than the capturing efficiency of the blowing dust collection filter 71 as described above, it is possible to make the pressure loss in the circulation port 52 higher than the pressure loss in the blast port 51, and therefore, it is possible to further increase the positive pressure in the housing space S . Further, it is possible to make it easy to keep the positive pressure state of the housing space S.

Further, although in the embodiment described above, there is illustrated the projector 1 provided with the three light. modulators 4R, 4G, and 4B, the present disclosure can also be applied to a projector for displaying a color picture with a single light modulator. Further, a digital mirror device can also be used as the light modulator.

Further, although in the embodiment described above, there is described the example of installing the light source device according to the present disclosure in the projector, this is not a limitation. The light source device according to the present disclosure can also be applied to lighting equipment, a headlight of a vehicle, and so on.

What is claimed is:

1. A light source device comprising:
a light source configured to emit light;
an optical element configured to affect the light emitted from the light source;
a first case configured. to house the light source and the optical element inside;
a blower configured to deliver air to inside of the first case; and
a second case configured to house the blower inside and coupled to the first case, wherein
the first case includes
a blast port through which the air delivered from the blower passes into the first case, and
a circulation port through which the air inside the first case passes into the second case.

2. The light source device according to claim 1, wherein
a first air amount per unit time of the air flowing into the first case via the blast port is higher than a second air amount per unit time of the air flowing into the second case from the first case via the circulation port.

3. The light source device according to claim 1, wherein
the second case includes an intake port through which air outside the light source device passes into the second case.

4. The light source device according to claim 3, further comprising:
a first filter disposed at the blast port; and
a second filter disposed at the intake port, wherein
a capturing efficiency of the first filter is higher than a capturing efficiency of the second filter.

5. The light source device according to claim 4, further comprising:
a third filter disposed at the circulation port, wherein
a capturing efficiency of the third filter is lower than the capturing efficiency of the first filter and is higher than the capturing efficiency of the second filter.

6. The light source device according to claim 3, further comprising:
a first filter disposed at the blast port; and
a second filter disposed at the intake port, wherein
a capturing efficiency of the second filter is higher than a capturing efficiency of the first filter.

7. The light source device according to claim 6, further comprising:
a third filter disposed at the circulation port, wherein
a capturing efficiency of the third filter is lower than the capturing efficiency of the first filter.

8. A projector comprising:
the light source device according to claim 1;
a light modulator configured to modulate the light emitted from the light source device; and
a projection optical device configured to project the light modulated by the light modulator.
